(19) United States
(12) Patent Application Publication
(10) Pub. No.: US 2010/0253185 A1
(43) Pub. Date: Oct. 7, 2010

(54) Addressable Information Display

(75) Inventors: Suryaprakash Kopparapu, Freeport, IL (US); William C. Stevenson, Chatsworth, CA (US); Steven V. Chesney, Lake Carroll, IL (US)

Correspondence Address: REINHART BOERNER VAN DEUREN P.C., 2215 PERRYGREEN WAY, ROCKFORD, IL, 61107, US

(73) Assignee: Seaga Manufacturing, Inc., Freeport, IL (US)

(21) Appl. No.: 12/418,277

(22) Filed: Apr. 3, 2009

(51) Int. Cl. A47F 3/14; G09F 11/00; G07D 7/00; H04N 5/66; H04N 3/14; H04N 5/70; H04Q 5/22

(52) U.S. Cl. 312/126; 40/1; 194/302; 348/739; 348/790; 348/800; 340/10.1; 348/E03.001; 348/E05.001

(57) ABSTRACT

A vending machine product storage tray system and vending machine system having the advantages of an addressable information display proximate to the vended product stored for sale therein is exposed.

### FIELD OF THE INVENTION

This invention generally relates to an information display system, more particularly an information display system for a vending machine.

### BACKGROUND OF THE INVENTION

Typical vending machines securely store and display vendable products for sale, generally stored on trays or within storage devices holding said products viewable to the consumer, with vendor identification and pricing information displayed upon printed media proximately associated with each product. To update such printed media information displays requires physical removal of the obsolete printed media, and then to replace this with new ones displaying the updated information.

In the operation of a vending business using such machines and printed media static information displays, this physical replacement of printed media typically requires high labor content and cost, as each display must be physically accessed from within the vending machine's secure enclosure for replacement. Error of information displayed is also a weakness resulting from requiring such manual media replacement by humans.

Thus there exists a need to provide a remote access means of accurately and quickly changing displayed information associated with vendable goods for sale without need for physical access to the information display media.

Therefore it is an objective of the present invention to provide an addressable information display possessing an accurate and quick means for changing data desired to be displayed on a vending machine product holding tray or other storage mechanism, and to expand the capabilities of a vending machine to more thoroughly inform vending machine users about pending purchases, and for the display of other useful data or information.

### BRIEF SUMMARY OF THE INVENTION

The present invention relates to a vending machine having addressable information displays located proximate to the product display trays and devices, to inform the machine's user of product order code, unit price and other useful information.

In one aspect, the invention provides a vending machine product holding tray having an addressable information display. The vending machine product holding tray includes a horizontal support plane and a plurality of vertical walls, which divides the product holding tray into a plurality of dispensing lanes supporting vendable products. The vending machine product holding tray further includes an information presentation plane attached to the horizontal support plane, wherein the information presentation plane supports at least one addressable information display.

In another aspect, the invention provides a remotely addressable information display module for retrofit attachment to a vending machine product holding tray. The remotely addressable information display module includes a circuit configured to receive data from remote control and a display surface.

In yet another aspect, the invention provides a vending machine including a secure enclosure, vendable product holding trays, dispensing mechanisms, a product delivery and pick-up area, a remotely addressable information display and a means of inputting data. The secure enclosure stores vendable objects that are in view of potential purchasers. The vendable product holding trays hold products. Dispensing mechanisms respond to payment and selection input from potential customers, and deliver vendable products as ordered. The product delivery and pick-up area is located in the interior of an outside accessible opening. The remotely addressable information display is located proximate the vendable product held ready for delivery from the vendable product holding trays. The remotely addressable information display is resettable with new information received from an internal control device. The means of inputting data inputs data to the internal control device for updating information displayed on the addressable information display.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 illustrates a vending machine product holding tray possessing printed media information display typical of the prior art;

FIG. 2 illustrates a vending machine product holding tray improved with an addressable information display according to a first preferred embodiment, and also illustrating alternative second and third preferred embodiments of the present invention;

FIG. 3 illustrates a vending machine product holding tray improved with an addressable information display according to a fourth preferred embodiment;

FIG. 4 illustrates a vending machine product holding tray improved with an addressable information display according to a fifth preferred embodiment of the present invention;

FIG. 5 illustrates a vending machine product holding tray improved with an add-on addressable information display according to a sixth embodiment of the present invention; and

FIG. 6 illustrates a vending machine incorporating addressable information displays and various remote means of transportably storing and inputting data to change the displayed information according to one embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

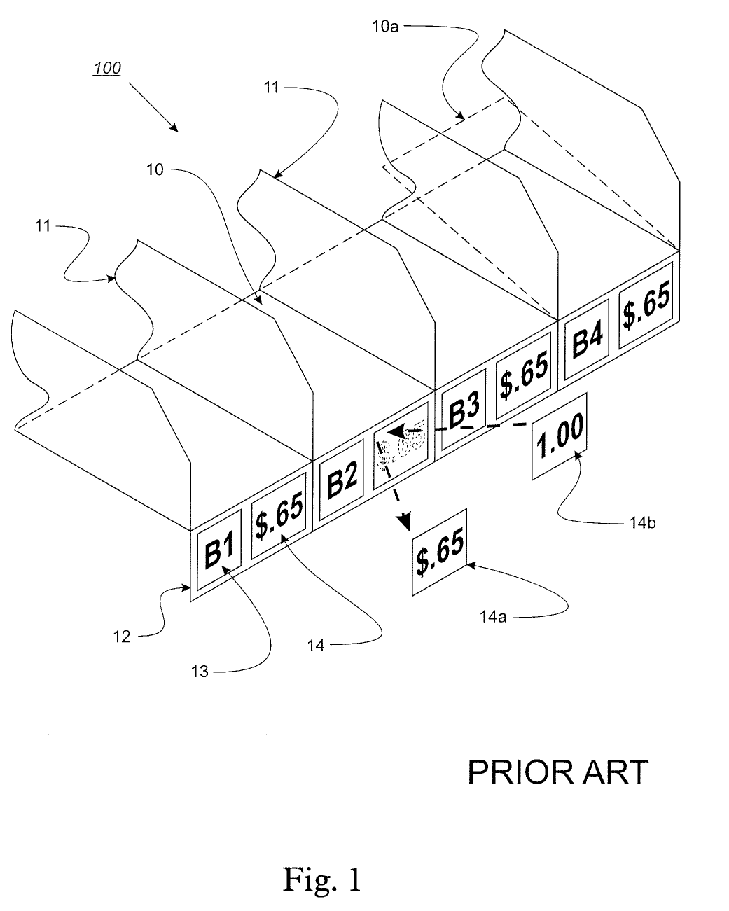

FIG. 1 is an illustration of a prior art vending machine product holding tray 100 consisting of a generally horizontal support plane 10, or alternately a sloped plane 10a, and a plurality of parallel vertical wall surfaces 11 dividing the tray into a plurality of generally front to back channels or lanes. An information presentation plane 12, located approximately at the front edge of horizontal support plane 10 allows the mounting of lane identification labels 13 and product pricing labels 14, thus providing a vending machine user an easy method of identifying the selection callout and price of a desired vendable product contained within the vending machine. To change the price of a vendable product, the vending machine operator has to manually replace a first price label 14a with an alternative price label 14b by first removing the existing obsolete price label 14a and replacing it with the new price label 14b.

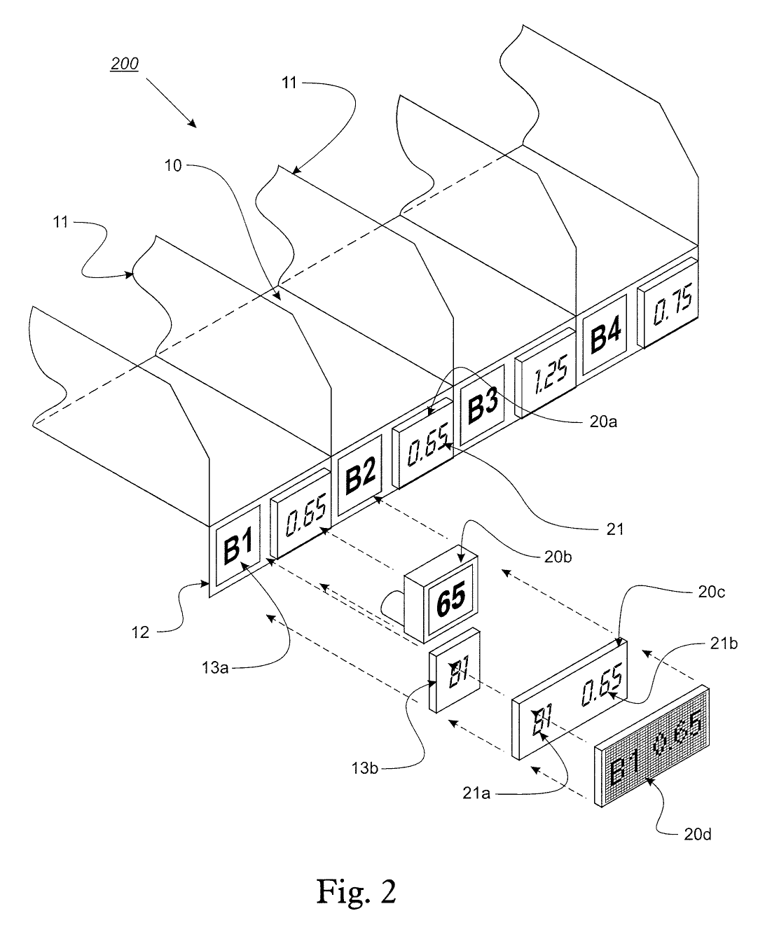

FIG. 2 illustrates a vending machine product holding tray 200 according to a first embodiment of the present invention. The vending machine product holding tray 200 includes a plurality of addressable price information displays, (electronic 20a, and mechanical/electro-mechanical 20b display devices) attached to the information presentation plane 12 located along the front edge of the horizontal support plane 10 of vending machine product holding tray 200, which also displays permanent location identification labels 13. A second preferred embodiment location identification addressable display 13b is also illustrated herein. The third preferred embodiment addressable display 20c illustrates both location 21a and price 21b information as an alpha-numeric segmented display. An alternate third preferred embodiment addressable information display method is illustrated herein as a dot-matrix display 20d, capable of displaying characters as well as complex shapes and animated images.

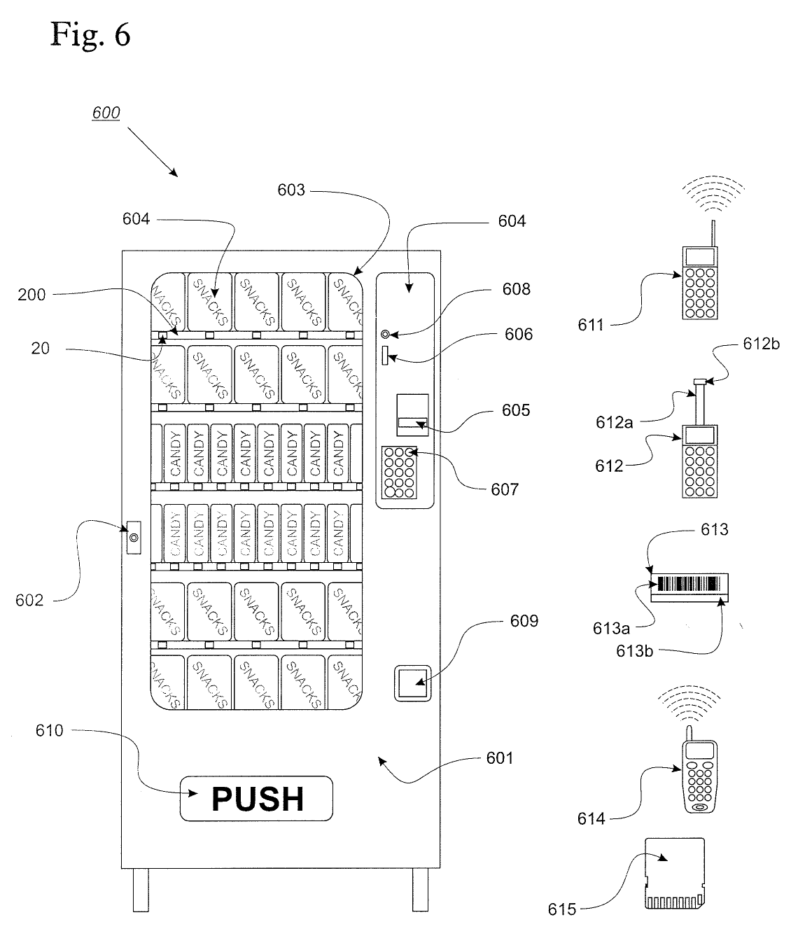

The information 21, 21a, 21b displayed on the plurality of addressable information displays 20a-20d can be automatically changed, using data retrieved from a remote controller 611 (FIG. 6) or other external data storage and retrieval means not illustrated here, without having to manually attend to the display itself. Said change of information data may also be manually input via a vending machine keypad 607 (FIG. 6).

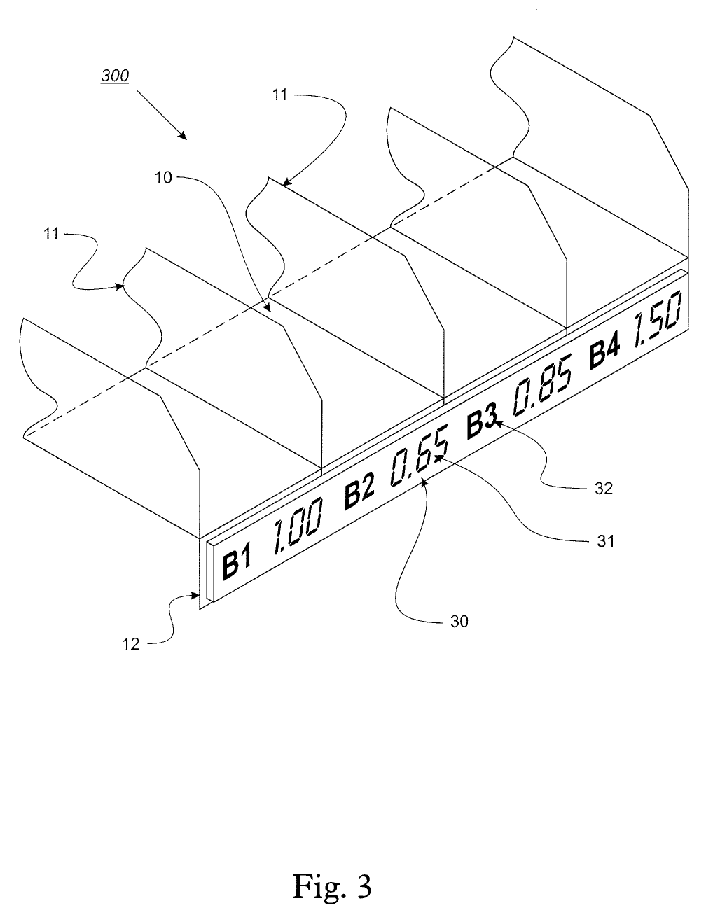

FIG. 3 illustrates a vending machine product holding tray 300 according to a fourth embodiment of the present invention. An addressable information display 30 is attached to the information presentation plane 12 approximately located along the front edge of the horizontal support plane 10 of vending machine product holding tray 300. The information 31, 32 displayed on the addressable information display 30 can be changed automatically, using for example a remote controller 611 (FIG. 6) without having to manually attend to the display itself. The illustrated addressable information display 30 substantially covers the front face of information presentation plane 12 maximizing said addressable information display area to display other additional information, lane identification 32 as directed by the remote controller.

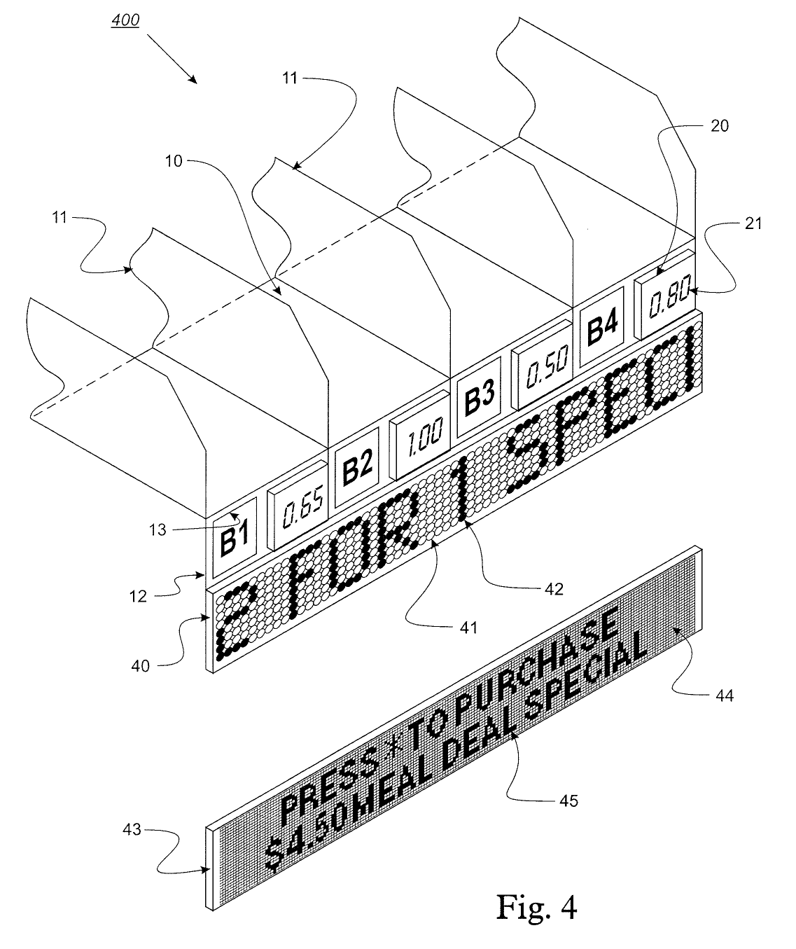

FIG. 4 illustrates a vending machine product holding tray 400 according to a fifth embodiment of the present invention. Addressable information displays 20 and 40 attached to the information presentation plane 12 located approximately along the front of the horizontal support plane 10 of vending machine product holding tray 400. This embodiment includes a horizontal row of a plurality of price display modules 20 displaying individual product pricing 21, which can be controlled using, for example, a remote controller 611 (FIG. 6). The price displays 20 alternate position with lane identification labels 13, beneath which a secondary addressable display 40 is sized to the horizontal length of information display plane 12. The secondary display 40, as shown in FIG. 4 is a matrix display of light emitting diodes 41 that displays illuminated information 42 for presentation in response to signals received from a remote controller 611 (FIG. 6). The secondary addressable display 40 may be attached via a hinge connection (not illustrated herein) to the bottom edge of the information presentation plane 12, thus to provide movement to a secondary addressable display 40 and to prevent blockage of product delivery from adjacent product holding trays (not illustrated herein). An alternate secondary addressable display 43 is shown as at least one dot-matrix display LCD panel 44, providing additional information display capability, for example, higher resolution character or image display 45 and an animation in multiple colors.

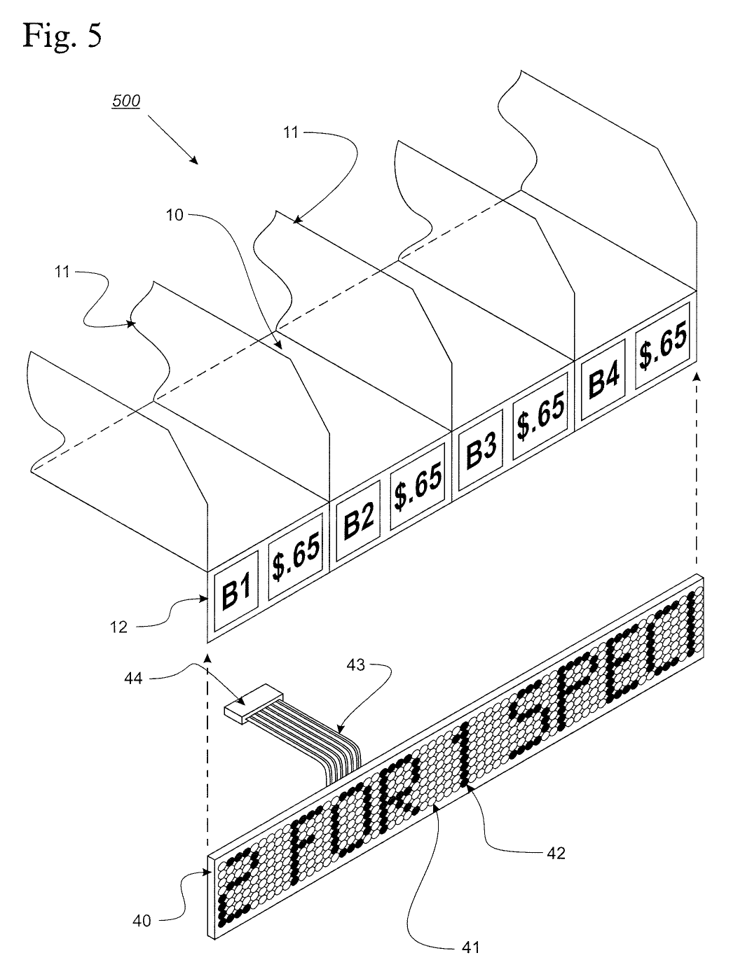

FIG. 5 illustrates a sixth embodiment, wherein a prior art vending machine product holding tray 500 is improved by the addition of an addressable display 40 attached to the bottom edge of the information display plane 12. The secondary display 40, is illustrated here as a matrix display of light emitting diodes 41 that presents illuminated information 42, wherein the information 42 can be changed using a remote controller 611 (FIG. 6) and is attached to the bottom edge of the information display plane 12. The secondary display 40 includes at least one multiple electrical conductor 43 terminating in electrical connector 44, which attaches to the vending machine controller, (not illustrated herein) to complete the circuit to transfer display information from the remote vending machine controller 611 (FIG. 6) to the addressable information display 40. The secondary addressable display 40 may be attached via a hinge connection (not illustrated herein) to the bottom edge of information presentation plane 12, thus to provide movement to secondary addressable display 40 and to prevent blockage of product delivery from adjacent product holding trays (not illustrated herein).

FIG. 6 illustrates a vending machine 600 having a secure enclosure cabinet 601 and having a lockable access 602. Machine 600 stores vendable products 604 for sale and displays them on said first embodiment trays 200 with addressable pricing displays 20 of the present invention viewable behind window 603. The vending machine 600 has a control panel 604 where a customer can make a payment via a bill acceptor 605 or via coin slot 606 before inputting their selection's order code via keypad 607. An internal control unit of the vending machine 600 calculates any change to be given, and the vending machine 600 delivers the calculated change in a coin return cup 609 after delivering the vended product 604 to a delivery area located behind the pickup access door 610. Pressing coin return button 608 cancels a credit, and returns all unused cash to the coin return cup 609. The price codes for displays 20 may be inputted to the control unit of the vending machine 600 via the keypad 607 or via a remote wireless input device 611. Also illustrated is a second remote input device 612 communicating information to addressable displays 20 via a communication cable 612a and connector 613b. Alternatively, price codes may be inputted to the control unit of the vending machine 600 via the connected bill acceptor 605 by inserting a card 613 having optical 613a and/or magnetic 613b data encoded thereon, or via a cellular phone 614, a solid-state memory device 615 or a modem (not illustrated herein). The remote wireless input device 611 may send input data via any sonic or electromagnetic wave, including but not limited to, visible and invisible light as well as radio waves such as those used in RFID circuits.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A vending machine product holding tray having an addressable information display comprising:
a horizontal support plane and a plurality of vertical walls dividing the product holding tray into a plurality of dispensing lanes supporting vendable products; and
an information presentation plane attached to the horizontal support plane, the information presentation plane supporting at least one addressable information display.

2. The vending machine product holding tray having an addressable information display according to claim 1, wherein the at least one addressable information display receives and displays a pricing information according to instructions sent from a remote control.

3. The vending machine product holding tray having an addressable information display according to claim 1, wherein the at least one addressable information display includes a mechanical indicator display.

4. The vending machine product holding tray having an addressable information display according to claim 1, wherein the at least one addressable information display includes an electromechanical indicator display.

5. The vending machine product holding tray having an addressable information display according to claim 1, wherein the at least one addressable information display includes an LED display.

6. The vending machine product holding tray having an addressable information display according to claim 1, wherein the at least one addressable information display includes an LCD display.

7. The vending machine product holding tray having an addressable information display according to claim 1, wherein the at least one addressable information display includes an electroluminescent display.

8. The vending machine product holding tray having an addressable information display according to claim 1, wherein the at least one addressable information display includes an OLED display.

9. The vending machine product holding tray having an addressable information display according to claim 1, wherein the at least one addressable information display includes an addressable matrix display.

10. The vending machine product holding tray having an addressable information display according to claim 1, wherein the at least one addressable information display includes a second tier remotely addressable information display.

11. A remotely addressable information display module for retrofit attachment to a vending machine product holding tray, the remotely addressable information display module comprising a circuit configured to receive data from a remote control, and a display surface.

12. The remotely addressable information display module according to claim 11, further comprising an LED display.

13. The remotely addressable information display module according to claim 11, further comprising an LCD display.

14. The remotely addressable information display module according to claim 11, further comprising an electroluminescent display.

15. The remotely addressable information display module according to claim 11, further comprising an OLED display.

16. The remotely addressable information display module according to claim 11, further comprising an addressable matrix display.

17. The remotely addressable information display module according to claim 11 further comprising a mechanical image display.

18. The remotely addressable information display module according to claim 11 further comprising an electromechanical image display.

19. A vending machine comprising:
a secure enclosure to store vendable objects that are in view of potential purchasers;
vendable product holding trays;
dispensing mechanisms respondent to payment and selection input from potential customers thus delivering vendable products as ordered;
a product delivery and pick-up area located in the interior of an outside accessible opening;
a remotely addressable information display located proximate the vendable product held ready for delivery from said vendable product holding trays, wherein said addressable information display is resettable with new information received from an internal control device; and
means for inputting data to said internal control device for updating information displayed on said addressable information display.

20. A vending machine according to claim 19 wherein said data input means being electromagnetic waves.

21. A vending machine according to claim 20 wherein said data input means being an electromagnetic transceiver.

22. A vending machine according to claim 21 wherein said electromagnetic transceiver is a radio device.

23. A vending machine according to claim 21 wherein said electromagnetic transceiver is a telephone.

24. A vending machine according to claim 21 wherein said electromagnetic transceiver is an RFID device.

25. A vending machine according to claim 21 wherein said electromagnetic transceiver is an smart card device.

26. A vending machine according to claim 21 wherein said electromagnetic transceiver is a wireless networking device.

27. A vending machine according to claim 21 wherein said electromagnetic transceiver is a modem.

28. A vending machine according to claim 19 wherein the means of inputting data generates electromagnetic spectrum waves inputtable to said internal control device, the electromagnetic spectrum waves having a wavelength between 100 μm-1,000 μm.

29. A vending machine according to claim 28 wherein said data input means is in the IR spectrum.

30. A vending machine according to claim 29 wherein said IR spectrum optical data input means is LED.

31. A vending machine according to claim 19 wherein said data input means also being a currency validation means.

32. A vending machine according to claim 31 wherein said currency validation means also reads barcode data.

33. A vending machine according to claim 31 wherein said currency validation means also reads magnetic striped data cards.

34. A vending machine according to claim 19 wherein said data input means also being a solid-state memory module.

35. A vending machine according to claim 19 wherein said data input means also being a keypad.

36. A vending machine according to claim 19 wherein said data input means also comprising sonic energy waves.
